(19) United States
(12) Patent Application Publication
(10) Pub. No.: US 2006/0150662 A1
(43) Pub. Date: Jul. 13, 2006

(54) Refrigerator and method for controlling the same

(75) Inventors: Gi Hyeong Lee, Gwangju-City (KR); Seong Ki Jeong, Yongin-Si (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 11/249,423

(22) Filed: Oct. 14, 2005

(30) Foreign Application Priority Data
Jan. 13, 2005 (KR) 2005-03395

(51) Int. Cl. G05D 23/00; F25D 11/02

(52) U.S. Cl. 62/441; 236/51

(57) ABSTRACT

A refrigerator and a method for controlling the same. The refrigerator having at least one storage chamber includes a food container for containing food; an RF tag attached to the food container for sensing a temperature of the food; an RF reader for reading data regarding the temperature of the food from the RF tag; and a controller for controlling an internal temperature of the storage chamber such that the temperature of the food read by the RF reader reaches a predetermined temperature. The refrigerator receives data regarding the temperature of the food by a non-contact manner, thus more precisely detecting the temperature of the food and storing the food in a fresh state for a long time compared to a conventional refrigerator.

### CROSS-REFERENCE TO RELATED APPLICATIONS

This application claims the benefit of Korean Patent Application No. 2005-3395, filed Jan. 13, 2005, in the Korean Intellectual Property Office, the disclosure of which is incorporated herein by reference.

### BACKGROUND OF THE INVENTION

1. Field of the Invention

The present invention relates to a refrigerator for sensing temperatures of foods and then performing cooling operation, and a method for controlling the same.

2. Description of the Related Art

Generally, refrigerators and kimchi refrigerators perform cooling operation according to temperatures of storage chambers sensed by temperature sensors installed in the storage chambers.

When a difference between the temperature in the storage chamber sensed by the temperature sensor and the temperature of food stored in a food container placed in the storage chamber occurs, the capacity of the refrigerator for storing food sensitive to temperature, such as kimchi, is remarkably decreased.

In order to solve the above problem, the conventional refrigerator includes a separate temperature sensor for sensing the temperature of food in addition to the temperature sensors for sensing the temperatures in the storage chambers. For example, Japanese Patent Laid-open Publication No. 2002-147916 discloses a technique in which a temperature of surrounding air of food is sensed by a temperature sensor installed close to the food stored in the storage chamber, in addition to a temperature sensor installed around a cold air outlet, and the temperature of the surrounding air of the food is applied to an equation so as to calculate the temperature of the food.

Since the above conventional technique calculates the temperature of the food using the temperature of the surrounding air of the food, a difference between the calculated temperature and a real temperature of the food still exists.

### SUMMARY OF THE INVENTION

Additional aspects and/or advantages of the invention will be set forth in part in the description which follows and, in part, will be apparent from the description, or may be learned by practice of the invention.

Therefore, one aspect of the invention is to provide a refrigerator which performs cooling operation by receiving data regarding temperature, sensed by a temperature sensing unit attached to a food container, in a non-contact manner, and a method for controlling the same.

In accordance with one aspect, the present invention provides a refrigerator having at least one storage chamber including: a food container for containing food; a Radio Frequency (RF) tag attached to the food container for sensing a temperature of the food; an RF reader for reading data regarding the temperature of the food from the RF tag; and a controller for controlling an internal temperature of the storage chamber such that the temperature of the food read by the RF reader reaches a predetermined temperature.

The RF tag may be attached to the inside of the food container.

Further, the RF tag may include a temperature sensing unit for sensing the temperature of the food, and a transmitting unit for transmitting the data, regarding the temperature of the food sensed by the temperature sensing unit, to the corresponding RF reader.

Moreover, the temperature sensing unit may be electrically connected to the transmitting unit.

The temperature sensing unit may be a semiconductor temperature sensor.

In the case that the refrigerator has a plurality of storage chambers, a plurality of RF readers are installed corresponding to the storage chambers, and respectively read data regarding the temperature of foods from the RF tags attached to food containers located in the corresponding storage chambers.

The refrigerator may further include a cooling unit for cooling the storage chamber, and the controller may control the cooling unit by comparing the temperature of the food to the predetermined temperature.

In accordance with a further aspect, the present invention provides a refrigerator including: at least one storage chamber; a food container placed in the storage chamber for containing food; a food temperature sensor installed in the food container for sensing a temperature of the food; a non-contact temperature detector for detecting data regarding the temperature of the food sensed by the food temperature sensor by a non-contact manner; a cooling unit for cooling the storage chamber; and a controller for controlling the cooling unit by comparing the temperature of the food detected by the non-contact temperature detector to a predetermined temperature.

The food temperature sensor may be installed in the food container.

Further, the non-contact temperature detector may include an RF tag and an RF reader for wirelessly transmitting a designated frequency to read the data regarding the temperature of the food.

In accordance with another aspect, the present invention provides a method for controlling a refrigerator having at least one storage chamber for storing a food container, including: attaching an RF tag having a temperature sensor to the food container; and sensing a temperature of food contained in the food container by wireless communication between the RF tag and an RF reader installed in the refrigerator, and performing cooling operation.

In accordance with yet another aspect, the present invention provides a method for controlling a refrigerator having at least one storage chamber, and a controller for controlling an internal temperature of the storage chamber, including: determining whether or not it is necessary to detect the internal temperature of the storage chamber; causing the controller to output temperature detecting instructions to an RF reader when it is necessary to detect the internal temperature of the storage chamber; causing the RF reader to wirelessly transmit a designated frequency to an RF tag attached to a food container located in the storage chamber; causing the RF tag to sense a temperature of food contained in the food container and to wirelessly transmit the sensed temperature of the food to the RF reader; causing the RF reader to supply data regarding the temperature of the food to a controller; and causing the controller to control a cooling unit by comparing the supplied data regarding the temperature of the food to a predetermined temperature.

### BRIEF DESCRIPTION OF THE DRAWINGS

These and/or other aspects and advantages of the invention will become apparent and more readily appreciated from the following description of the embodiments, taken in conjunction with the accompanying drawings in which:

FIG. 1 is a schematic view illustrating an RF tag attached to a food container in accordance with the present invention;

FIG. 2 is a schematic view of the configuration of a refrigerator, to which data regarding temperatures of foods stored in storage chambers are supplied, in accordance with the present invention;

FIG. 3 is a block diagram for controlling the refrigerator of the present invention; and

FIG. 4 is a flow chart illustrating a method for controlling the refrigerator in accordance with the present invention.

### DETAILED DESCRIPTION OF THE PREFERRED EMBODIMENTS

Reference will now be made in detail to the embodiments of the present invention, an example of which is illustrated in the accompanying drawings, wherein like reference numerals refer to like elements throughout. The embodiments are described below to explain the present invention by referring to the annexed drawings.

The present invention is applied to a refrigerator having storage chambers for storing food, such as kimchi, which includes an RF tag having a temperature-detecting function attached to a food container so as to precisely detect the temperature of the food, and receives data regarding the temperature of the food detected by the RF tag in a non-contact manner.

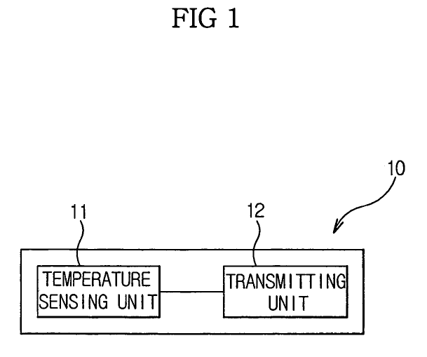

As shown in FIG. 1, an RF tag 10 includes a temperature sensing unit 11 and a transmitting unit 12, and may be attached to the inside of a food container so that the RF tag 10 is located close to food in the food container. The temperature sensing unit 11 has a small size, and may employ a semiconductor temperature sensor for outputting a voltage signal corresponding to a sensed temperature thereof. The transmitting unit 12 is electrically connected to the temperature sensing unit 11, and transmits data regarding the temperature of the food.

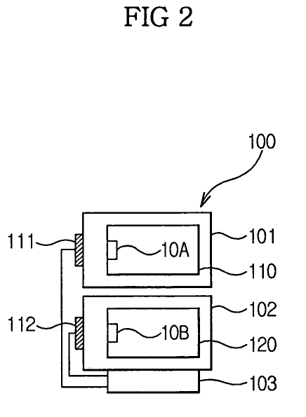

As shown in FIG. 2, a refrigerator 100 includes a plurality of storage chambers 101 and 102, and a controller 103 for controlling cooling operation of the storage chambers 101 and 102. In the cooling operation, the controller 103 controls the temperature in the storage chambers 101 and 102 based on the data regarding the temperatures of foods supplied from a plurality of readers 111 and 112.

The readers 111 and 112 are installed corresponding to the storage chambers 101 and 102. The first reader 111 reads data regarding the temperature of food from an RF tag 10A attached to a first food container 110 located in the first storage chamber 101, and the second reader 112 reads data regarding the temperature of food from an RF tag 10B attached to a second food container 120 located in the second storage chamber 102.

The reading operation of the data regarding the temperature of food is performed by control instructions of the controller 103.

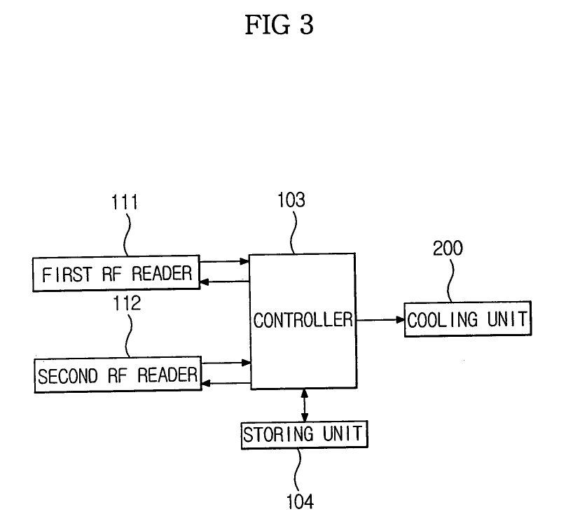

As shown in FIG. 3, when the controller 103 outputs temperature-detecting instructions for reading the temperature of food to all or one of the plural RF readers 111 and 112, the RF reader(s), to which the temperature-detecting instructions are applied, wirelessly transmit a designated frequency to the food container in the storage chamber.

The RF tag, which receives the frequency wirelessly transmitted from the RF reader, generates induced current, and thus generates operating voltage. When the RF tag generates the operating voltage, the temperature sensing unit of the RF tag outputs a voltage signal, corresponding to data regarding the temperature of food, to the transmitting unit, and the transmitting unit transmits the data regarding the temperature of food to the corresponding RF reader.

The RF reader supplies the received temperature of food to the controller 103. The controller 103 detects a predetermined temperature of the corresponding storage chamber, set by a user, from a storing unit 104. Thereafter, the controller 103 compares the data regarding the temperature of food supplied from the RF reader to the detected predetermined temperature, and determines whether or not it is necessary to perform cooling operation on the corresponding storage chamber. As a result of the determination, when it is necessary to perform the cooling operation on the corresponding storage chamber, a cooling unit 200 drives a compressor (not shown), a cooling fan (not shown), and a valve (not shown), thereby performing the cooling operation.

During the cooling operation, when the temperature of the food supplied from the RF reader reaches the predetermined temperature, the controller 103 stops the cooling operation.

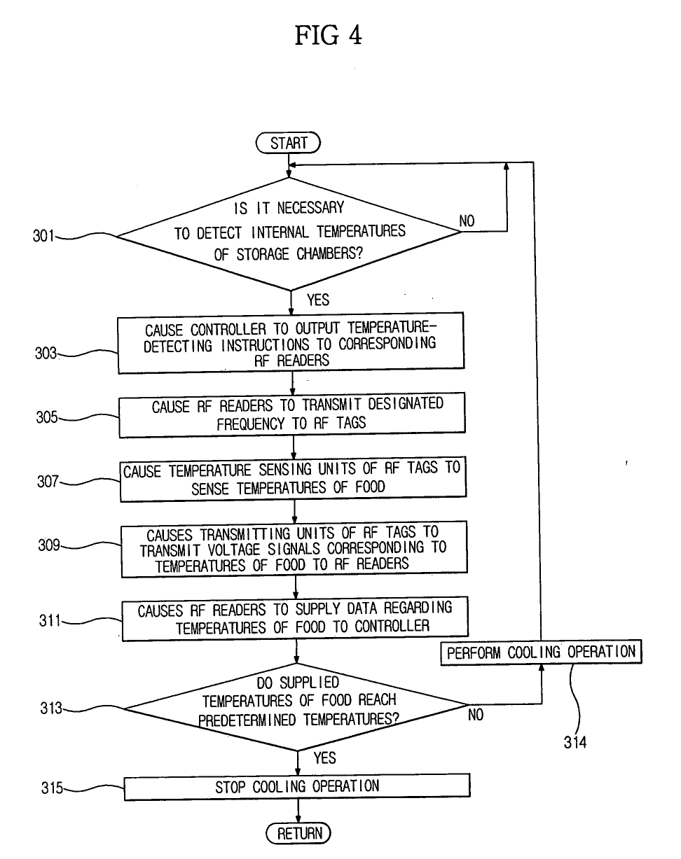

Hereinafter, with reference to FIG. 4, a method for controlling the refrigerator of the present invention will be described in detail.

The controller 103 determines whether or not it is necessary to detect internal temperatures of the plural storage chambers 101 and 102 (operation 301). As a result of the determination, when it is determined that it is necessary to detect the internal temperatures of the storage chambers 101 and 102, the controller 103 outputs temperature-detecting instructions to the RF readers 111 and 112 corresponding to the storage chambers 101 and 102 requiring the detection of the internal temperature thereof (operation 303). The RF readers 111 and 112, which received the temperature-detecting instructions, transmit a designated frequency to the RF tags 10A and 10B (operation 305). The RF tags 10A and 10B, which received the frequency, generate induced current, and thus generate operating voltage. Then, the temperature sensing units of the RF tags 10A and 10B sense temperatures of foods stored in the storage chambers 110 and 120 (operation 307), and the transmitting units of the RF tags 10A and 10B transmit voltage signals, corresponding to the temperatures sensed by the temperature sensing units, to the corresponding RF readers 111 and 112 (operation 309). The RF readers 111 and 112 apply data regarding the temperatures of foods to the controller 103 (operation 311).

The controller 103 determines whether or not the supplied temperatures of foods reach the predetermined temperatures stored in the storing unit 104 (operation 313). As a result of the determination, when the supplied temperatures of food are higher than the corresponding predetermined temperatures, the controller 103 controls the cooling unit 200 such that cooling operation is performed (operation 314), and then returns the method to operation 301.

As a result of the determination of operation 313, when the supplied temperatures of foods reach the predetermined temperatures, the controller 103 controls the cooling unit 200 such that the cooling operation is stopped (operation 315).

As apparent from the above description, the present invention provides a refrigerator, which receives data regarding the temperature of food sensed by a temperature sensing unit attached to food container, and a method for controlling the refrigerator, thereby more precisely detecting the temperature of food than a conventional refrigerator calculating the temperature of food from the temperature of a storage chamber. Accordingly, since cooling operation is performed according to predetermined temperature set by characteristics of food, the refrigerator of the present invention and the method for controlling the same can store food in a fresh state for a long time.

Although embodiments of the invention have been shown and described, it would be appreciated by those skilled in the art that changes may be made in these embodiments without departing from the principles and spirit of the invention, the scope of which is defined in the claims and their equivalents.

What is claimed is:

1. A refrigerator having at least one storage chamber comprising:
a food container for containing food;
an RF tag attached to the food container for sensing a temperature of the food;
an RF reader for reading data regarding the temperature of the food from the RF tag; and
a controller for controlling an internal temperature of the storage chamber such that the temperature of the food read by the RF reader reaches a predetermined temperature.

2. The refrigerator as set forth in claim 1, wherein the RF tag is attached to the inside of the food container.

3. The refrigerator as set forth in claim 1, wherein the RF tag comprises a temperature sensing unit for sensing the temperature of the food, and a transmitting unit for transmitting the data regarding the temperature of the food, sensed by the temperature sensing unit, to the RF reader.

4. The refrigerator as set forth in claim 3, wherein the temperature sensing unit is electrically connected to the transmitting unit.

5. The refrigerator as set forth in claim 3, wherein the temperature sensing unit is a semiconductor temperature sensor.

6. The refrigerator as set forth in claim 1, wherein, in the case that the refrigerator has a plurality of storage chambers, a plurality of RF readers are installed corresponding to the plural storage chambers, and respectively read data regarding the temperature of foods from the RF tags attached to food containers located in the corresponding storage chambers.

7. The refrigerator as set forth in claim 1, further comprising a cooling unit for cooling the storage chamber,
wherein the controller controls the cooling unit by comparing the temperature of the food to the predetermined temperature.

8. A refrigerator comprising:
at least one storage chamber;
a food container placed in the storage chamber for containing food;
a food temperature sensor installed in the food container for sensing a temperature of the food;
a non-contact temperature detector for detecting data regarding the temperature of the food sensed by the food temperature sensor by a non-contact manner;
a cooling unit for cooling the storage chamber; and
a controller for controlling the cooling unit by comparing the temperature of the food detected by the non-contact temperature detector to a predetermined temperature.

9. The refrigerator as set forth in claim 8, wherein the food temperature sensor is installed in the food container.

10. The refrigerator as set forth in claim 8, wherein the non-contact temperature detector includes an RF tag and an RF reader for wirelessly transmitting a designated frequency to read the data regarding the temperature of the food.

11. A method for controlling a refrigerator having at least one storage chamber for storing a food container, comprising:
attaching an RF tag having a temperature sensor to the food container; and
sensing a temperature of food contained in the food container by wireless communication between the RF tag and an RF reader installed in the refrigerator, and performing cooling operation.

12. A method for controlling a refrigerator having at least one storage chamber, and a controller for controlling an internal temperature of the storage chamber, comprising:
determining whether or not it is necessary to detect the internal temperature of the storage chamber;
causing the controller to output temperature-detecting instructions to an RF reader when it is necessary to detect the internal temperature of the storage chamber;
causing the RF reader to wirelessly transmit a designated frequency to an RF tag attached to a food container located in the storage chamber;
causing the RF tag to sense a temperature of food contained in the food container and to wirelessly transmit the sensed temperature of the food to the RF reader;
causing the RF reader to supply data regarding the temperature of the food to a controller; and
causing the controller to control a cooling unit by comparing the supplied data regarding the temperature of the food to a predetermined temperature.

13. The method of claim 12, wherein the RF tag is placed on the interior of the food container.

14. The method of claim 12, wherein the RF tag comprises a temperature sensing unit for sensing the temperature of the food, and a transmitting unit for transmitting the data regarding the temperature of the food, sensed by the temperature sensing unit, to the RF reader.

15. The method of claim 14, wherein the temperature sensing unit is electrically coupled to the transmitting unit.

16. The method of claim 14, wherein the temperature sensing unit is a semiconductor temperature sensor.

17. The method of claim 12, wherein, in the case that the refrigerator has a plurality of storage chambers, a plurality of RF readers are installed corresponding to the storage chambers, and respectively read data regarding the temperature of foods from the RF tags attached to food containers located in the corresponding storage chambers.
